(19) United States
(12) Patent Application Publication
(10) Pub. No.: US 2010/0293448 A1
(43) Pub. Date: Nov. 18, 2010

(54) CENTRALIZED WEBSITE LOCAL CONTENT CUSTOMIZATION

(75) Inventors: Nahum Rand, Las Vegas, NV (US); Thomas J. Waits, Westminster, CO (US); William Daniel Worrell, Longmont, CO (US)

Correspondence Address: HOGAN LOVELLS US LLP, ONE TABOR CENTER, SUITE 1500, 1200 SEVENTEENTH ST, DENVER, CO, 80202, US

(73) Assignee: InfoNow Corporation, Denver, CO (US)

(21) Appl. No.: 12/780,418

(22) Filed: May 14, 2010

Related U.S. Application Data
(60) Provisional application No. 61/178,801, filed on May 15, 2009.

(51) Int. Cl. G06F 17/30; G06F 15/16; G06F 3/048

(52) U.S. Cl. 715/206; 709/203; 715/235; 707/737; 707/E17.018; 707/E17.115; 715/739

(57) ABSTRACT

A plurality of geographic locations can be individually associated with separate web pages by identifying and placing in a database geographic specific content. By linking geographic location to specific content housed within the database and then using that content to populate a hypertext markup language (HTML) web page template, a plurality of individual customized web pages can be created that are both indexable and extractable. Each level of data within the database comprises geographic specific data common to a region or location that is the focus of the web page. The structured nature of the database data enables web crawlers or indexers which are associated with various search engines to identify each specific level by way of the particular file much like that of a link within an existing web page.

### RELATED APPLICATION

The present application relates to and claims the benefit of priority to U.S. Provisional Patent Application Ser. No. 61/178,801 filed May 15, 2009, which is hereby incorporated by reference in its entirety for all purposes as if fully set forth herein.

### BACKGROUND OF THE INVENTION

1. Field of the Invention

Embodiments of the present invention relate, in general, to web content and more particularly to centralized customization of localized web content.

2. Relevant Background

Increasingly, business data processing systems, entertainment systems, and personal communications systems are implemented by computers across networks that are interconnected by internetworks (e.g., the Internet). The Internet has emerged as a preferred system for distributing and exchanging data of many forms. Data exchanges support applications including electronic commerce, social networking, e-mail, broadcast and multicast messaging, videoconferencing, gaming, and the like. In electronic commerce (e-commerce) applications, it is important to provide a satisfying informative and buying experience that leads to a purchase transaction. To provide this high level of service, a website operator must not only ensure that data is delivered to the customer in the most timely, usable and efficient fashion but that the information is focused to meet the needs of the customer.

The Internet is a collection of disparate computers and networks coupled together by a web of interconnections using standardized communications protocols. While most Internet access is currently performed using conventional personal computers and workstations, the variety of devices that access the Internet is growing quickly and expected to continue to grow. It is expected that a variety of appliances and devices within offices, businesses, and households will support Internet connectivity in the coming years. A major segment of growth is in the area of lightweight computing appliances. Examples include wireless telephones, personal digital assistants (PDAs), digital picture frames, digital music, and digital movies.

With the advent of the Internet, computing appliances that can act as interfaces have potentially ubiquitous access to a wealth of stored information. As the amount of available data is overwhelming, a variety of search tools has evolved to aid in a user's ability to quickly identify pertinent information.

Search engines such as Google, Yahoo!, and MSN employ sophisticated algorithms to deliver to a requestor content that is as closely as possible aligned to the requestor's interest. There are numerous factors that go into the determination of which content should be presented to each request and in what order those results should be presented.

Typically a key word search reveals websites that most likely contain all or most of those key words within the website itself. This is referred to as an organic search. As one might expect, many websites participating in the same market space may contain the same key words. For example, a search for “ping pong table” using one search engine returns approximately 2 million websites that include one or more of those three words. Of the approximately 2 million websites responding to the inquiry, only 10 are listed on the first result screen. And as one might expect, the vast majority of individuals conducting such searches rarely look beyond the initially presented (the top 10 list) results. Thus, from an e-commerce point of view, being listed on the first page of results of a search conducted on an industry sector or market of interest is very significant.

Included with the organic search results, many search engines prominently display sponsored links. In the previous example of “ping pong table”, three highlighted websites appear apart from the organic results. These sponsored websites meet the organic search criteria but may not necessarily be listed on the first page of results.

The objective of any search engine is to provide to a requestor the most useful and pertinent information possible. By doing so the search engine builds customer loyalty. As the user finds that his or her request is reliably and accurately answered, he or she becomes more and more likely to use a particular search engine over another. As loyalty builds the search engine can monetize that loyalty and demand fees from content providers that wish to offer sponsored sites associated with search phrases that may relate to their particular products or services.

One feature to enhance the requestor's experience and loyalty is localizing his or her search. While current search engine methodology is to simply match content on a web page with key search words, if there are geographic words or attributes on the web page that match geographic aspects with respect to a user's search request then the match may be more geographically relevant. Google, Yahoo!, and MSN are “theme” based search engines. This means that they associate a theme with a web page according to its content. If the theme of the content consistently matches the keywords searched, the web page is given more relevancy. The more local content provided, the more locally relevant the theme becomes, and the more relevant the web page becomes the more likely it is to be presented as one of the top 10 search results. Thus a key word search for “Pizza Parlor Denver” would more likely find a website that includes a Denver relevant content and is based on a Denver or Rocky Mountain theme than a generic Pizza Parlor website that, while more popular overall, fails to include content relevant to the Denver locality.

Research has shown that a vast majority of searches on the Internet involve a search for products within the requestor's local area. Many users simply use the Internet to find brick and mortar shops in their local community carrying a particular type of product. They also use the Internet via a search engine to find the locations of particular types of restaurants (e.g. pizza parlors) or to find the closest ATMs or banks.

As is well known in the art, search engines can determine the general location from which the request is initiated by querying the IP address of the requestor even when the requestor does not include a geographic key word. When a computer establishes a session on the Internet it is assigned an IP address. These addresses are typically assigned by the Internet Service Provider (ISP) to which the computer is linked. Each ISP possesses a range of IP addresses which it can use for any regional area in which it provides its Internet service.

By knowing the location of the ranges of each ISP, a search engine receiving a request from an ISP can determine to some degree the location of the computer making the request. For example, assume that a company in Los Angles contracts with Qwest Communications™ for its Internet service. Qwest, by agreement with the FCC, can issue IP addresses within certain ranges for each of its locations. Assume that Qwest owns IP address 72.XXX.XX.XXX. In this case the 72 may indicate that the IP address is associated with Qwest, and the rest is assigned by Qwest dynamically. Qwest may then use the remaining digits to identify various sectors within its network. Thus an IP address of 72.166.34.140 may indicate a Qwest assigned IP address located in Los Angels, Calif. or even a particular portion of Los Angles.

Since the request gives its IP address to the search engine, the search engine can use the IP address to return results that are pertinent to that general location. Thus a user typing in “pizza parlor” having an IP address in Los Angeles, Calif. would be given the generic and sponsored links for pizza parlors in Los Angeles and not those in New York City, even though the links in New York City may be more “generically” correct.

Generic search results are based on a complicated and often proprietary analysis of the correlation between a web page and aspects of the search initiated by a user. As illustrated above, one aspect of that search may be the user's location based on the originating IP address. But generally speaking the results returned are ranked by how relevant various aspects of a web page are to the specified search terms. Thus locally orientated searches identify web pages having a high volume of pertinent local content.

For large enterprises having locations throughout the country and world the content they provide is usually centrally managed. In many instances the content of web pages serving local institutions for a large enterprise is dynamically generated using a generic template upon receipt of a request for local content. For example and continuing the previous example, a user may search for a Domino's Pizza parlor in Los Angeles by going to the Domino's general web page and using a link for nearby locations. By either using the inherent IP address of the user or explicit geographic information, a local web page can be generated providing the requested information for Domino's Pizza in Los Angeles. However, prior to this dynamic generation of the web page, that web page did not exist and upon its closing it will cease to exist.

For a search engine to match a particular search with one or more web pages the search engine must first index and categorize those web pages. As is well known search engines crawl the web to index new and existing web pages constantly. So a dynamically produced web page, while pertinent to the request, would not be available to the search engine for indexing and thus would not be recognized by the search engine if a search for local content was initiated.

To provide content that a search engine would recognize as being local, the content provider would have to create and maintain content for each locality in which it has a presence. Then when the search engine indexes content it would locate and examine web pages showing Domino's, a national brand pizza franchise, has several locations within the Los Angeles region. Currently this requires large enterprises to maintain content for literally thousands of websites. And if a general change to the web page is initiated by the company, thousands of web pages must be individually modified. This is both inefficient and expensive. Needed are methods and systems to centrally customize local website content. These and other issues are addressed by one or more embodiments of the present invention.

### SUMMARY OF THE INVENTION

A system, with corresponding methodology, centrally manages the customization of local content in a plurality of web pages. According to one embodiment of the present invention, a plurality of geographic locations can be individually associated with separate web pages by identifying and placing in a database geographic specific content. By linking geographic location to specific content housed within a database and then using that content to populate a hypertext markup language (HTML) web page template, a plurality of individual customized web pages can be created that are both indexable and extractable.

According to one embodiment of the present invention, a structured relational database is created to house geographic specific data with increasing detail in accordance with each level of data or geographic information in the database. Each level of data in the database comprises geographic specific data common to a region or location that is the focus of the web page. A plurality of levels can be created up to the point in which the final level houses incrementally specific geographic details about a particular web page.

Upon the need to alter data modifications can be made at any or all of the levels thereby affecting those levels and web pages that are derived from an overarching or higher level.

The structured nature of the database enables web crawlers or indexers which are associated with various search engines to identify each specific level by way of the particular file much like that of a link within an existing web page. Thus upon indexing of the originating web page each of the specific geographic web pages is identified by a unique universal resource locator (URL). Each geographic web page, while created dynamically and centrally managed, is, to a web crawler or indexer, a separate web page. Thus the central management of a plurality of geographically specific web pages is transparent to a search engine.

Another embodiment of the present invention describes a system for centralized management of geographically customized web pages that, in its most basic form, includes a client and host computer communicatively coupled together by a wide area network such as the Internet. One of reasonable skill in the art will recognize that the embodiments the present invention are equally applicable and implementable using other forms of networks such a local area network, intranet, wireless network and the like.

In such an embodiment the host computer, also sometimes referred to as a web server, houses a web page manager and a location module. The web page manager includes a HTML web page template that is configured to be populated by geographic content of increasing specificity. The geographic content is housed in a database which is linked to the web page manager so that upon receipt of a request for a web page of a specific geographic location as interpreted by the location module, a web page template is populated with specific geographic content.

The database presents structured data such that a search engine web crawler would view and identify the geographic specific content as having a unique repeatable path which can be tagged with a URL. As each geographic specific web page is individually labeled with a URL, it becomes discoverable via an organic web search which ultimately increases the chance of a high placement during web searches.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE SEVERAL VIEWS OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a networked computer environment in which, according to one embodiment, the present invention is implemented;

FIG. 2 is a high level block diagram of a system for centralized customization of website content according to one embodiment of the present invention;

FIG. 3 is a screen shot of one embodiment of a user interface for centralized management local web page content according to the present invention;

FIG. 4 is a high level graphical depiction of a relational database for centralized management of local web pages according to one embodiment of the present invention;

FIG. 5 is a screen shot of an end user web page in which centralized local web page management according to the present invention is implemented; and

FIG. 6 is a flowchart of one method embodiment for centralized local web page management according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

A system and method for centralized customization of local of content is hereafter described by way of example. According to one embodiment of the present invention a plurality of web pages can be customized with specific local content based on their geography by utilizing a database linked with the web page template. Once a specific geographic location is identified, content from the database can be used to populate a web page template forming a plurality of unique web pages.

As a database is centrally managed the geographic specific content can be modified efficiently and with minimal cost. Moreover the database presents a structured system in which a web searching tool such as Google or Yahoo, can index the geographic specific content and identify each combination of content as a separate web page.

The following description with reference to the accompanying drawings is provided to assist in a comprehensive understanding of exemplary embodiments of the present invention as defined by the claims and their equivalents. It includes various specific details to assist in that understanding but, which are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide.

Included in the description are flowcharts depicting examples of the methodology which may be used to manage geographic specific content. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

One embodiment of the present invention enables content providers to centrally customize local web page content using what is referred to herein as a web page manager or locator. A content management system generally includes a computer application that is used to create, edit, manage, search and publish various kinds of digital media and electronic text. Central management systems are frequently used for storing, controlling, versioning, and publishing industry-specific documentation such as news articles, operators' manuals, technical manuals, sales guides, and marketing brochures. The content managed may include computer files, image media, audio files, video files, electronic documents, and web content.

When the centralizing feature is an address or a geographic location, a web page can be localized by indexing the content of the web page independent of the actual location of the web page. According to one embodiment of the present invention, a plurality of web pages can be localized by indexing each web page with a network of locations and then reducing duplicate content within the localized content found across the newly created network of web pages. Using the web page manager a content provider can add content that will be displayed for a specific geography, such as state, city, country, etc. The content can be text, meta data, images, video, etc. As a result, the invention reduces duplicate content, which can significantly degrade search engine performance, across the many web pages that are generated.

Recall that the world wide web portion of the Internet operates on a client/server model, and in such a model a client computer operating a web browser, or similar client software such as Microsoft Internet Explorer or Apple Safari, contacts a web server or host computer with a request. The web browser displays information on the client computer by interpreting web pages built under the HTML format. Accordingly any HTML files tell the web browser how to display the text, graphics, links, and multimedia filed on one or more particular web pages. The HTML files loaded by the browser, however do not contain the actual graphics, sound, or other resource files. Rather, it contains links to the graphics or other files which are located on the server.

The files which the client computer seeks are identified on the server computer by use of a universal resource locator or URL. A URL is a multifaceted string of letters indicating not only the protocol used for the communication but the actual location of the content. The first part of a URL indicates which type of transfer protocol will be used to retrieve a specific document. The most common request is for a hypertext document that uses the HTPP protocol format. Next is the location of the specific host computer on which the document or web page resides. This part of the address is often called the domain. Domain names include a suffix such as .com, .edu, .gov and the like. Next is a directory on the host computer that contains a specific website or web content. A host computer can house multiple websites or multiple web pages. This segment of the address is essentially the root directory that houses content for the site. A subdirectory might also be indicated in this part of the address. The last portion of a URL is the format of the specific web page that is being requested.

When a user requests a web page using a web browser, the web browser installed on the client computer converts that request to a URL which is thereafter sent to the server. The host computer, which is identified by the URL, receives the request and determines whether the web page requested is resident on the host computer or whether the host computer must seek additional information to fulfill the client computer's request. Once the web page is found or created the host computer transmits the information back to the client. The browser on the client computer receives the information and displays it to the user.

Search engines utilize the system to index and categorize each and every web page of the Internet. Web crawlers, as they have become known, scour the Internet to identify new and modified web pages and return to the search engine an index of the URLs or paths by which each web page can be identified. According to one embodiment of the present invention the database used to customize geographic content in web pages provides a structured environment which can be identified by the search engine crawlers as unique and identifiable web pages.

Each search engine uses a crawler with its own set of rules guiding how documents and web pages are gathered. Some follow every link and every home page defined and then, in turn, examine every link on each of those new home pages and so on and so on. Some crawlers ignore links that lead to geographic or graphic files, found files and animation files. Others ignore links of certain Internet resources such as news groups and some are instructed to look for the most popular home page. It can take a crawler several seconds to many minutes to examine each site depending on the size and the complexity of the website.

Once the crawler identifies the content and/or its URL the Web crawler is directed to collect such information and send it to indexing software hosted by the search engine.

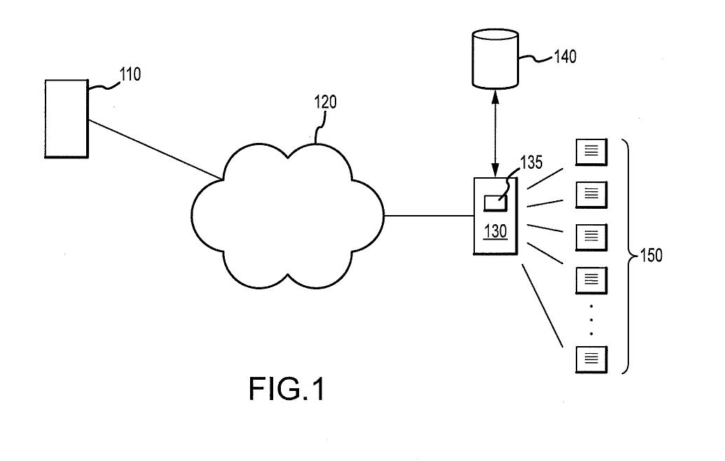

One aspect of the present invention is the ability to centrally modify and manage geographically specific web page content. As shown in FIG. 1, a client computer 110 operating a web browser communicatively connects with a server or host computer 130 via a wide area network 120 such as the Internet. Resident on the host computer is a web page management and customization module 135. This module in connection with a database 140 creates a plurality of geographically based customized web pages 150 using content housed in the database 140. Using an interface to the web page management module referred to as a profile insight module a user can create and/or modify geographically specific content and add geographic areas by which to classify the content. Each geographic area shares the same textual content. For example a number of locations within the same state or postal code may possess the same general text describing local region.

As used herein, a “Component” is a piece of the invention that stores and retrieves a certain type of content, such as text, video, weather, etc. It may also be referred to herein as a module or engine. The term “Locator” or “web page manager” as used herein is a module of instructions operable on a processor or similar computer capable of executing code embodied as software for managing location (geographic) content for one or more locations.

As can be appreciated by one skilled in the art, the ability to centrally manage content in a structured manner so that that it can be indexed by a search engine is not limited to geographic applications. Indeed the present invention contemplates and is capable of managing a variety of different qualifying attributes about a particular type of content. For example, in other embodiments of the present invention the managed feature may be time/date or gender (if such information can be gained from the requestor).

Embodiments of the present invention include both a front end, to enter data, and a back end to store and retrieve data. The front end is used, according to one embodiment, to insert geographic specific content for a particular region or location.

The back end of the web page manager can be used to retrieve content associated with a geographic area or any other specified criteria.

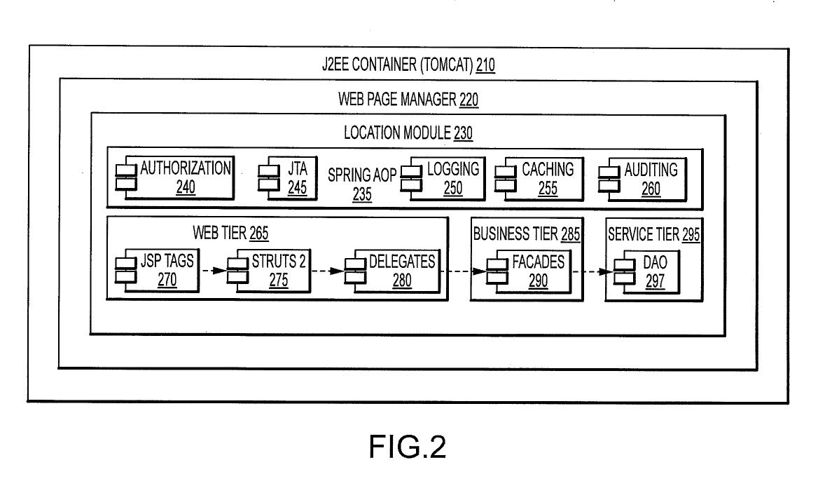

FIG. 2 is a high level block diagram showing one embodiment of the components for centralized web page content customization and management system. According to one embodiment of the present invention a J2EE container 210 such as Tomcat is utilized to host an environment for dynamic content management. Within the Tomcat environment 210 exists the web page management module 220 and the location module 230. One means of implementing the present invention is to use Spring Aspect-Oriented Programming (AOP) 235 to wire the components and services together. Spring AOP 235 is an aspect-oriented approach to applying crosscutting concerns across the application.

Spring AOP allows a user to inject authorization 240, transaction management (JTA) 245, logging 250, caching 255, and auditing 260, among other things, into the location module code 230 where needed. In the web tier 265 the present invention can use Java Server Pages (JSP) 270, Struts2 275, and/or a collection of business delegates 280 to render the view in a browser and communicate to the business tier 285. The business tier 285 of the model presented is made up of a set of service facades 290 wherein each service facade abstracts the services in the service tier 295 into an interface (DAO) 297 that can be used by the web tier to create new locator instances, email a user etc. The goal of the service facades is to expose the underlying services in higher level, application focused, interfaces.

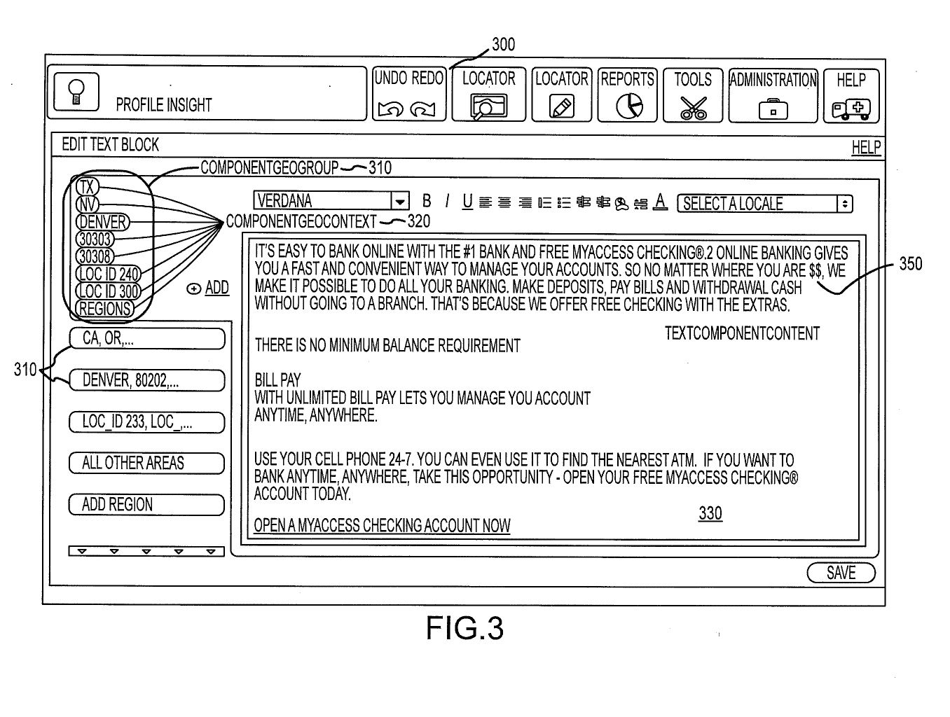

FIG. 3 is a screen shot of a web interface for centralized management local web pages. As previously discussed the examples described herein are framed based on a geographic hierarchical structure with increasing specificity. While the terminology and discussion uses location or geography to describe the invention, other terms and categorizations can be used without departing from the scope of the present invention. Turning back to FIG. 3, shown is an interface 300 allowing a user to manage the content association within specific geographic constraints. The interface enables a user to open a particular Component_Instance 330 in which the content can be modified for each geographically identified region.

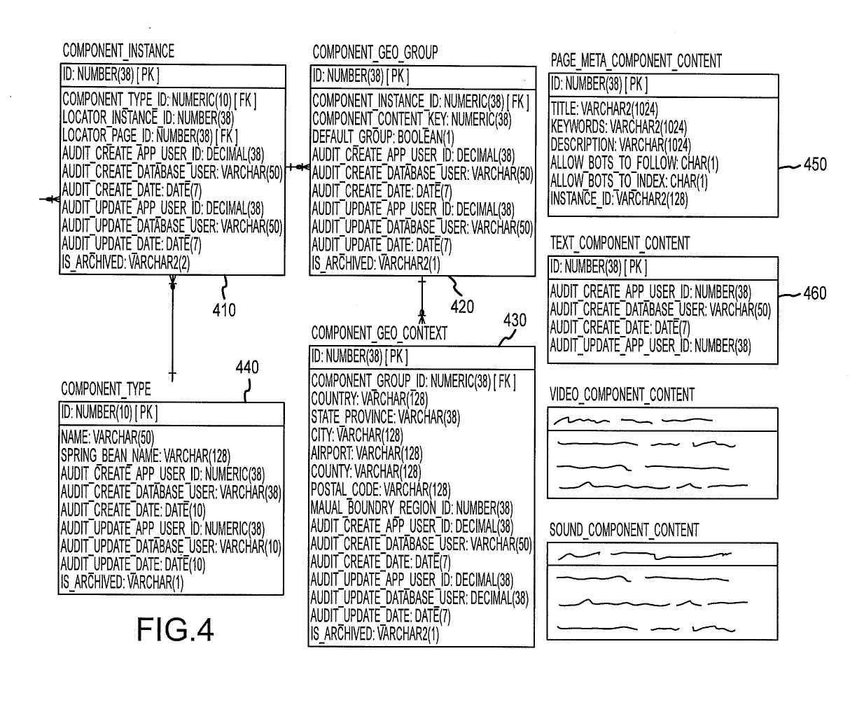

On the left side of the Component_Instance 330 are a plurality of tabs each representing a Component_Geo_Group 310. These groups can be defined based on known parameters, such as regional or national boundaries, or defined arbitrarily. As will be discussed more with reference to FIG. 4, each Component_Geo_Group 310 is related to a Component_Instance 330 and Component_Instances are of a variety of types. In this embodiment the Component_Geo_Group 310 can be based on consumer preferences, demographics or any other criteria by which to base dissemination of the content.

As shown the Component_Geo_Group of the display page include 4 groups 310. They are TX NV . . ., CA OR, Phoenix, 80202 and LOC_ID 233. Each group 310 resides at a similar level or layer in the database despite the fact that the first two groups represent states, the third a city and the last an arbitrary location. Each Component_Geo_Group 310 includes a set of Component_Geo_Contexts 320 wherein each Component_Geo_Context 320 represents a sub geographic attribute within a particular group, e.g. Denver is within the TX NV group. Similarly the Component_Geo_Context can identify relationships between a country, state, county, city, neighborhood, etc. Lastly each Component_Geo_Group is associated by a Component_Content_Key with one or more forms of content from one of the Components. In this example the Text Component 340 is associated with the Component_Geo_Group 310 TX, NV.

Content can be of a variety of forms. In FIG. 3 the content being associated with the TX, NV group is the text stating “It's easy to bank online . . . ” Other forms of content such as video, imagery, sound, etc. can also be associated with the same geographic group. According to one embodiment of the present invention a particular portion of content is associated with a particular geographic grouping.

In operation a user will request a webpage associated with a specific geographic location. For example banking locations in Texas. There may be several banking locations in Texas but each of the locations in Texas will include textual content tailored for that geographic region. In this case the textual content will be identical to that presented to a request for banking locations in Nevada and the city of Denver but likely different from an inquiry for banking information in California. The depiction of FIG. 3 is the interface with which a user can modify and associate this common content.

FIG. 4 shows one embodiment of a relational database structure for storage and association of content used for the centralized management of local web pages. As discussed with reference to FIG. 3, FIG. 4 shows the relationship between various tables of the database. As is known to one of reasonable skill in the art, a relational database matches data by using common characteristics found within the data set. The resulting groups of data can thus be organized and made easier to comprehend. Strictly a relational database is a collection of relations, sometimes referred to as tables. In a relational database all data are stored and accessed via these relations. A relation can be defined as a set of tuples or ordered list of elements that have the same attribute. A tuple normally represents an object or information about that object and maps attributes to values. That is, tuples indicate that an object consists of certain components, but the components are identified by name instead of position, which leads to a more user-friendly and practical notation, for example: (player : “Harry”, score : 25) In this notation, attribute—value pairs may appear in any order and are all related.

It should also be appreciated that while the present invention is described in terms of a relational database, other forms of data storage can be utilized without departing from the spirit and scope of the present invention. While the relational database structure is implemented in one preferred embodiment of the present invention other data storage and retrieval structures are equally compatible with the present invention.

The context of the user interface shown in FIG. 3 can be better understood with reference to a relational depiction shown in FIG. 4. In this embodiment of the present invention four relations or tables provide structure to the geographic data. These include Component_Type 440, Component_Instance 410, Component_Geo_Group 420 and Component_Geo_Context 430. Text_Component_Content 460 and Page_Meta_Component_Content 450 are but two types of content associated with each Component_Geo_Group 420 and its associated Component_Geo_Contexts 430. A variety of content types can be utilized. The Component_Instance 410 represents an instance of a component on an individual page of a locator. Each Component_Instance is an instance of a Component_Type 440. The Component_Type 440 stores which type of Component holds the content. This could be Text Component 460, Meta_Data_Component 450, etc.

A Component_Context further modifies the content associated with a particular group. Accordingly changes to the text 340 in the Text_Component_Content will be displayed when the search parameter contains one of the Component_Geo_Contexts in the Component_Geo_Group that is associated with this content. Therefore a request for Banks in Denver, while being within the TX, NV group, will slightly modify the text to present a response more appropriate to the rocky mountain region than the deserts of Nevada or the open spaces of Texas.

To add a store or retrieve a particular piece of content, one embodiment of the present invention creates a JSP tag library which uniquely identifies which Component_Instance is to be displayed on the page. The main tag will have the web page manager engine (Locator) ID, the page ID, and an instance ID. These three IDs together determine what content is displayed by defining a particular instance of a particular component.

The hierarchy of the IDs is as follows:
Locator ID, global to the Profile Insight application
   Page ID, relative to the Locator ID
      Instance ID, relative to the Page ID

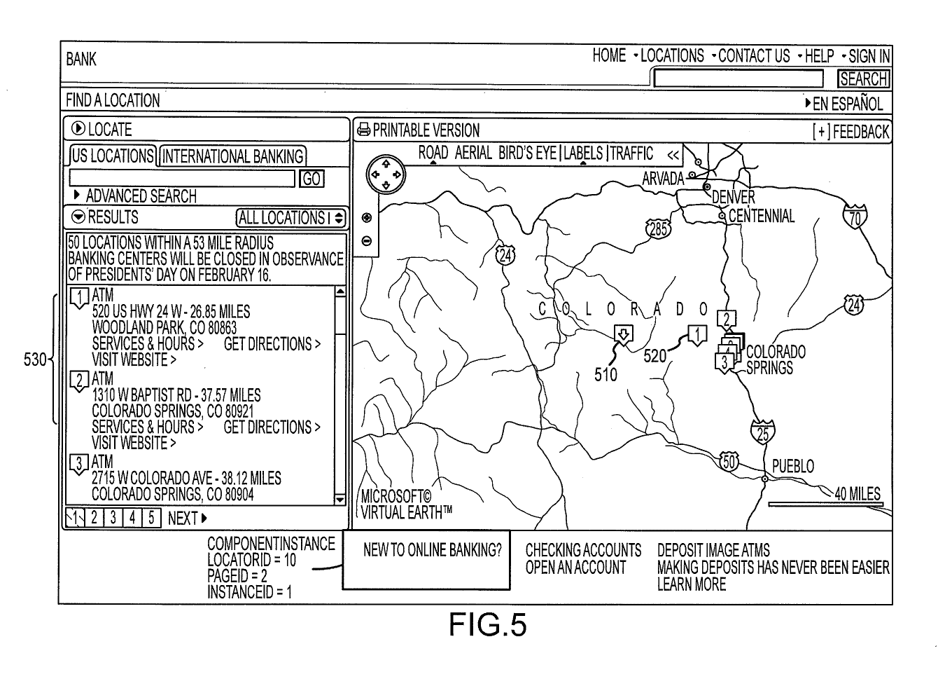

FIG. 5 is a screen shot of a typical web page in which one embodiment of centralized local web page management tools of the present invention are utilized. In the screen shot shown a query occurs to find Bank ATMs. In this example the Bank is a large multistate organization with several regions and branches located throughout the country. Indeed, with respect to ATMs a single branch may be responsible for multiple ATMs. For example the branch itself may have an ATM resident at its location but there may also be ATMs at the local grocery store or free standing ATMs at popular locations throughout the city. The present invention allows web pages to be generated depicting this data that is centrally managed and indexable so that a search engine can extract the information making it available via a generic search.

In the example depicted, a user has entered the bank's website and selected a link to find the nearest ATM location. Based on either data entered by the user, such as postal code, or based on the IP address of the user, the website accessed localized content from the database to populate the web page shown in FIG. 5. Here a map of the local area is shown giving the user's position 510 and the nearest ATM 520. In addition textual descriptions 530 of the ATMs corresponding to the ATMs illustrated on the map are provided. As shown on the Bank ATM Locator, there is a TextComponent that is uniquely identified by the three IDs (locatorID=10, pageID=2, instanceID=1). This textual component may be common to all ATM search result web pages, but nonetheless be associated with data linking that component to the locality presented. In this case the text states, “New to Online Banking?” Based on the location of the requestor, Colorado, a local website, if chosen, regarding Online banking would be populated by using these three IDs. Furthermore, the search engines, when indexing websites, identifies this link as a local website thus making it likely to be presented when local information is directed. So if a generic search were made for online banking in Colorado the search engine would identify the web page identified by this link as populated by the three IDs as a local bank offering Online Banking. Therefore the national banking chain would present a local presence to an online searcher.

According to one embodiment of the present invention, Component_Geo_Group.Compenent_Content_Key is the means used to retrieve the content from a component. Turning attention once again to FIG. 4, the individual geographies that make up Component_Geo_Group are represented as rows in the Component_Geo_Context table wherein one row is used for each geography. The actual content is stored in one of the Component_Content tables.

Each Component is free to store its content any way the developer decides. All that is required is for the Component to implement the service tier Component interface and the yet to be defined web tier component interface. While code level details are beyond the scope of this description as present in the JavaDoc and Java code, the main functionality of the service tier Component interface is to save content, returning a numeric key to that content, and retrieve content for a specific numeric key.

The centralized local web page management of the present invention also enables a user to share content among a plurality of locations. The Shared_Component defines an infrastructure for associating component data to geographic areas. These interfaces include:
a. Component, the main communication interface.
b. Component_Content, the data interface.

The Component Manager further supplies variable replacement for any component. All the variables to be replaced will have the “$$” prefix. Note that in the second line of the Text Component_Content 340 of FIG. 3 the content states, “ . . . So no matter where you are in $$city, we make it . . . ” In that case a variable textual content will replace the $$city based on the locator ID.

According to one embodiment of the present invention the component implements methodology from Component_Content.
getTextContent( )

This method returns an ordered List of strings that have variables to replace.
setTextContent(List<String).

The items in this List must be in the same order they were received from the call to getTextContent( )

Any object that interfaces with the Context, which is passed in to the ComponentManager and passed down all the way to the component, can add a VariableReplacement implementation to the List<VariableReplacement> variableReplacementList contained in the Context Object.

The most likely places for this are:
The Locator web application; and
The ComponentManager, which is the default implementation.
The ComponentManager applies the VariableReplacement objects to the list of String obtained from the Component in the order they appear in the list.]

Another aspect of the present invention is its ability to point outgoing links across localized websites based on geography or other managed features. A typical website design includes multiple links to other websites. Those websites may lead to other websites forming a matrix of related sites. Indeed this is one reason for the characterization of website interactions as a web. For example a website for a California business may point to other pages that are California centered. They in turn may link to one another or to other businesses within their local area and these local websites may link to sites outside of the state. Similarly, a Chicago based mortgage company may have links to other Illinois based loan pages.

According to one embodiment of the present invention, these inter-links are managed and controlled locally using the present invention. This inter-linking can strongly affect a website's (page's) page-rank and controlling these inter-links locally allows for strongly affecting a page's PageRank. PageRank relies on the uniquely democratic nature of the web by using its vast link structure as an indicator of an individual page's value. In essence, the search engine interprets a link from page A to page B as a single vote, by page A, for page B. But, normally the search engine such as Google looks at more than the sheer volume of votes, or links a page receives; it also analyzes the page that casts the vote. Votes cast by pages that are themselves “important” weigh more heavily and help to make other pages “important.”

In other words, a PageRank results from a “ballot” among all the other pages on the World Wide Web regarding that page's importance. A hyperlink to a page counts as a vote of support. The PageRank of a page is defined recursively and depends on the number and PageRank metric of all pages to which it links (incoming links). A page that is linked to by many pages with high PageRank receives a high rank itself. If there are no links to a web page there is no support for that page. According to one embodiment of the present invention a page's PageRank can be increased by managing/controlling the page's inter-links.

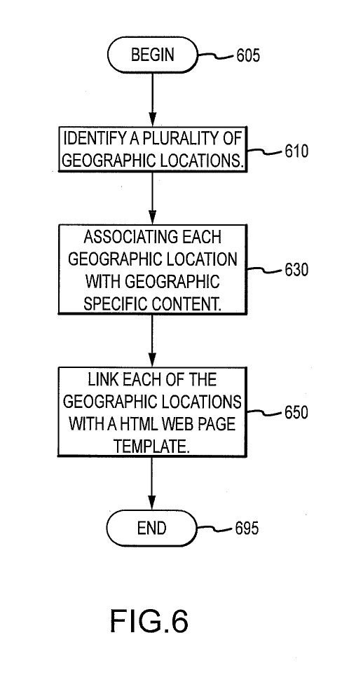

FIG. 6 presents a flowchart of one method embodiment of the present invention for centralized customization of local web page content. The customization of a web page based on local content begins 605 with the identification of a plurality of geographic areas 610 for which each of the web pages will be customized. For each location specific content is identified and organized and thereafter stored in a database. Each of the geographic locations is linked 630 to HTML web page template which acts as the basis for a plurality of localized web pages. This web page template is then associated 650 with specific geographic content for each of the geographic locations as housed in the database.

Upon a user seeking local information the web page manager is provided with a request associated with a specific location. Using that data the web page manager access the template and populates the template with content specific to that locality. The hierarchical nature of the data structure presents a clear path by which to identify each specific rendition of the web page template. Rather than having a single template with several instances of data, the present invention's hierarchical data structure presents a plurality of locally specific data paths which represents each of the local web pages. A URL thus exists for each specific population of the HTML template with local data.

From a user's or web crawler's perspective a plurality of web pages exist wherein each web page is specific to a particular location. If the URL is known, a user could precisely and directly navigate to that particular web page. Thus a web crawler can index each of these web page paths, URLs, so that each is associated with a locality along with its relative area of influence. For example a national banking web site for ATMs in a particular location would be recognized when a local search for ATM is conducted even though the website is centrally managed.

From a managers perspective the present invention enables a plurality of web pages to be centrally managed and dynamically created without sacrificing the ability of those websites to be locally indexed and identified. The content of each web page, or a grouping of web pages within a common area, can be modified easily and efficiently. As the need to maintain each web page individually is eliminated, overhead in the from of server capability and memory can be reduced without any loss of capability to provide a localized web page or any loss of market penetration resulting from web searches.

In preferred embodiments, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

An exemplary system for implementing the invention includes a general purpose computing device in the form of a conventional personal computer, a personal communication device or the like, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer, such as magnetic cassettes, flash memory cards, digital video disks, random access memories (RAMS), read-only memories (ROMs) and the like may also be used in the exemplary operating environment.

A number of program modules may be stored on the hard disk, magnetic disk, ROM or RAM, including an operating system, one or more application programs or software portions, other program modules and program data. A user may enter commands and information into the personal computer through input devices such as a keyboard and pointing device. Other input devices may include a microphone, joystick, game pad, satellite dish, scanner or the like. These and other input devices are often connected to the processing unit through a serial port interface that is coupled to the system bus, but may be connected by other interfaces, such as a parallel port, game port or universal serial bus (USB). A monitor or other type of display device may also connected to the system bus via an interface, such as a video adapter.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with a system for local customization of web page content, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for centralized customization of local web page content, comprising:
identifying a plurality of geographic locations wherein each geographic location is associated with geographic specific content;
linking each of the plurality of geographic locations with a hypertext markup language (HTML) web page template; and
associating the HTML web page template with geographic specific content for each of the plurality of geographic locations according to a hierarchical structure.

2. The method of claim 1 wherein geographic specific content is partitioned into a database according to the hierarchical structure wherein each level of the hierarchical structure is of increasing specificity.

3. The method of claim 2 wherein geographic specific content can be modified at each distinct level of data in the database.

4. The method of claim 3 wherein each distinct level of data in the database includes content common to a specific geographic location.

5. The method of claim 4 wherein content at each distinct level of data in the database can be centrally managed and modified.

6. The method of claim 1 wherein each of the plurality of geographic locations can be arbitrarily designated.

7. The method of claim 1 wherein the hierarchical structure is associated with a plurality of unique uniform resource locators.

8. A system for centralized local content web page customization, comprising:
a client computer;
a host computer communicatively coupled to the client computer by a network wherein the host computer includes a web page manager;
a database associated with the host computer and linked to the web page manager wherein the database includes geographic specific content; and
a location module resident on the host computer and associated with the web page manager wherein the location module is configured to create a web page for each hierarchical combination of geographic specific content.

9. The system of claim 8 wherein the database includes a plurality of levels, each level with increasing specificity.

10. The system of claim 9 wherein content at each level of the database can be centrally managed.

11. The system of claim 8 responsive to receiving from the client computer a location, the location module is configured to identify a web page populated with geographic specific content associated with the location.

12. The system of claim 11 wherein the location can be ascertained either explicitly or implicitly.

13. The system of claim 8 wherein each created web page is associated with a specific hierarchical structure based on the database.

14. The system of claim 13 wherein each created web page is indexable according to the specific hierarchical structure.

15. A computer-readable storage medium tangibly embodying a program of instructions executable by a machine wherein said program of instructions comprises a plurality of program codes for customizing local content on a web page, said program of instructions comprising:
program code for identifying a geographic location;
program code for associating the geographic location with a commensurate portion of hierarchical structured data in a database; and
program code for populating a hypertext markup language (HTML) web page with geographic specific content linked to the commensurate portion of hierarchical structured data in the database associated with the geographic location.

16. The system of claim 15 wherein indentifying includes receiving an explicit location from a client computer.

17. The system of claim 15 wherein indentifying includes ascertaining an implicit location of a client from an Internet protocol address.

18. The system of claim 15 including program code for associating the populated HTML web page with a unique universal resource locator.

19. The system of claim 15 including program code for associating the commensurate portion of hierarchical structured data in the database with a unique universal resource locator.

20. The system of claim 19 wherein the unique universal resource locator is indexable.
